(19) United States
(12) Patent Application Publication
(10) Pub. No.: US 2026/0235410 A1
(43) Pub. Date: Aug. 13, 2026

(54) SYSTEMS AND METHODS FOR DETERMINING SPATIAL FEASIBILITY OF MOVING OBJECTS THROUGH PHYSICAL ENVIRONMENTS USING SWEPT-VOLUME ANALYSIS

(71) Applicant: Ryan P Reilly, Mount Prospect, IL (US)

(72) Inventor: Ryan P Reilly, Mount Prospect, IL (US)

(21) Appl. No.: 19/637,141

(22) Filed: Apr. 2, 2026

Related U.S. Application Data
(60) Provisional application No. 63/787,780, filed on Apr. 12, 2025.

(51) Int. Cl. G01C 21/20; G06Q 10/047; G06T 17/00; G06T 19/00

(52) U.S. Cl. CPC G01C 21/206; G06T 17/00; G06T 19/006; G06Q 10/047; G06T 2210/04; G06T 2210/21

(57) ABSTRACT

Computer-implemented systems and methods for determining spatial traversal feasibility of an object through a physical environment are disclosed. Spatial data is captured using sensors on a computing device and used to generate a three-dimensional environment model. Dimensional information describing an object is obtained and candidate movement paths comprising combinations of rotational and translational movement are evaluated. For each path, a swept volume representing the spatial envelope occupied by the object during simulated movement is computed. Intersections between the swept volume and structural boundaries are detected to determine whether collision-free traversal paths exist. Identified paths are ranked by optimization scores based on clearance margin, rotation magnitude, movement distance, and predicted user effort. The system generates augmented reality movement guidance when a feasible path is identified, or a no-fit output when none exists. Applications include residential moving, appliance delivery, retail pre-purchase verification, logistics, construction planning, and robotic manipulation.

Priority: This application claims priority to U.S. Provisional Patent Application No. 63/787,780, filed Apr. 12, 2025, the entire disclosure of which is incorporated herein by reference.

### CROSS-REFERENCE TO RELATED APPLICATIONS

This application claims priority to U.S. Provisional Patent Application No. 63/787,780, filed Apr. 12, 2025, the entire disclosure of which is incorporated herein by reference.

### FIELD OF THE INVENTION

The present disclosure relates generally to spatial analysis, motion planning, and movement guidance technologies. More particularly, the disclosure relates to computer-implemented systems and methods for determining whether an object can traverse a physical environment by computing a swept volume occupied by the object during rotational and translational movement, detecting intersections of the swept volume with environmental boundaries, and generating guidance instructions for moving the object through the environment.

### BACKGROUND OF THE INVENTION

Moving large objects through constrained physical environments presents significant challenges in residential, commercial, and industrial contexts. Examples include transporting furniture through doorways and hallways, delivering appliances into buildings, moving equipment within facilities, relocating construction materials within structures, and maneuvering objects through stairwells and elevator shafts.

Determining whether an object can traverse a particular path requires complex spatial reasoning that extends beyond simple dimensional comparison. Prior approaches have focused on comparing maximum object dimensions against opening dimensions; however, such approaches fail to account for the dynamic geometry occupied by an object during rotational and translational movement. When an object is rotated and translated simultaneously through a constrained space, it occupies a continuously changing volume—referred to herein as a swept volume—that may substantially exceed the object's static bounding dimensions.

For example, a sofa that is narrower than a doorway may nonetheless be unable to pass through that doorway if, during the required rotation, portions of the sofa sweep through wall surfaces, ceiling surfaces, or floor obstacles. Existing tools do not model or analyze this swept-volume geometry and therefore fail to predict traversal feasibility with accuracy.

In logistics and delivery contexts, failed delivery attempts caused by spatial constraints require rescheduling, return transport, additional labor resources, and generate significant costs. Industry estimates suggest that failed large-item deliveries in furniture and appliance sectors cost hundreds of millions of dollars annually in the United States alone. In construction or renovation scenarios, inaccurate planning may result in costly delays or the need to remove structural elements to permit installation of equipment or materials.

Accordingly, there exists a need for improved systems and methods capable of capturing spatial data describing a physical environment, generating three-dimensional models of objects and environments, computing swept volumes representing the space occupied by objects during simulated movement, detecting collisions between swept volumes and environmental boundaries, and providing guidance regarding whether and how objects can be moved through constrained environments.

### SUMMARY OF THE INVENTION

The present disclosure provides systems and methods for determining spatial traversal feasibility of objects through physical environments using swept-volume collision analysis.

In one aspect, the disclosure provides a computer-implemented method comprising: obtaining spatial data representing a physical environment, wherein the spatial data is captured by one or more sensors or retrieved from a stored spatial model; generating a three-dimensional model of the physical environment from the spatial data; obtaining dimensional information describing an object; evaluating a plurality of candidate movement paths comprising combinations of rotational and translational movement of the object through the three-dimensional model; computing, for each candidate movement path, a swept volume representing the complete spatial envelope occupied by the object during the simulated rotational and translational movement along that path; detecting intersections between each swept volume and structural boundaries of the physical environment; determining whether one or more collision-free traversal paths exist based on the detected intersections; selecting a traversal path from among any identified collision-free traversal paths, wherein the selection is based on at least one optimization criterion; and generating movement instructions describing traversal of the selected traversal path.

In certain embodiments, when a collision-free traversal path is identified, the system generates visual movement instructions presented through an augmented reality overlay displayed on a computing device, providing step-by-step rotational and translational guidance to assist a user in moving the object along the determined path.

In certain embodiments, the system determines that traversal is not feasible and generates output indicating that the object cannot traverse the environment, optionally identifying alternative entry paths or suggesting object disassembly.

The disclosed systems and methods may be applied across numerous contexts including residential moving, furniture delivery, appliance installation, construction planning, logistics operations, robotic manipulation systems, and automated warehouse environments. In certain implementations, the system may be integrated with retail platforms to enable pre-purchase delivery feasibility verification. In other implementations, the system may be used by delivery personnel to verify entry path feasibility prior to unloading objects from delivery vehicles.

### BRIEF DESCRIPTION OF THE DRAWINGS

FIG. 1 illustrates a system architecture for determining spatial feasibility of moving an object through an environment.

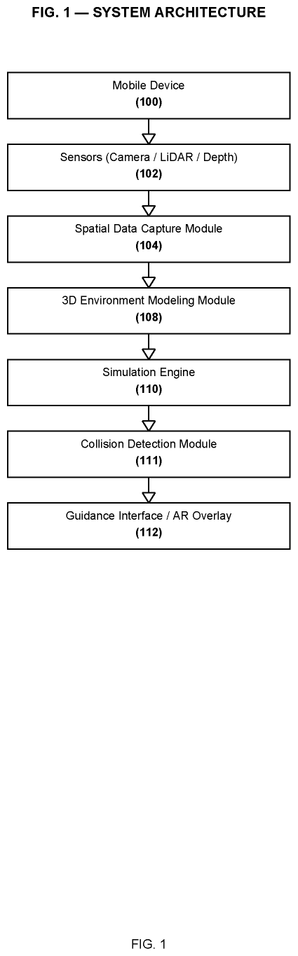

FIG. 2 illustrates capturing spatial data representing a physical environment using a mobile computing device.

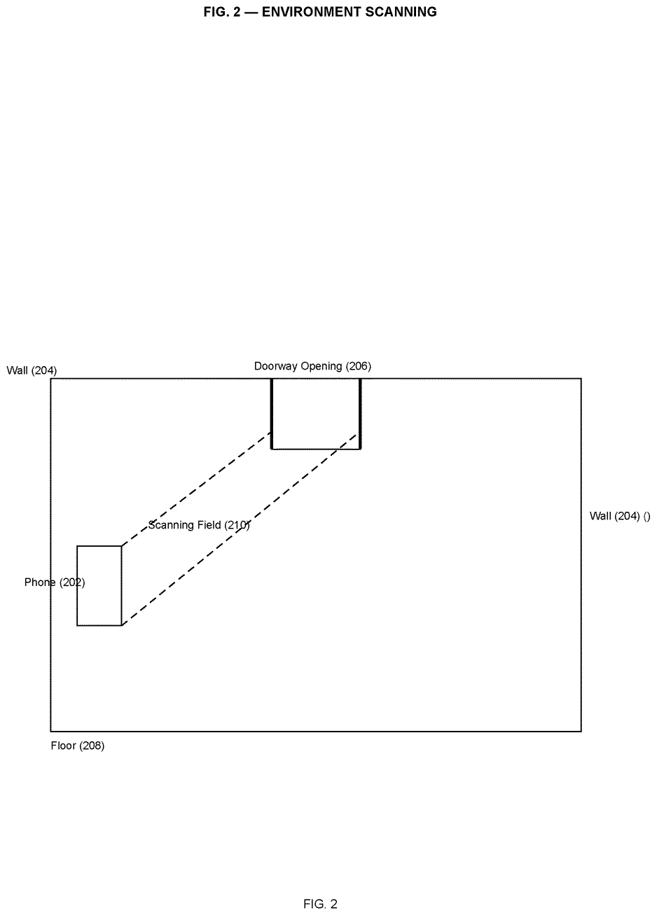

FIG. 3 illustrates generation of a three-dimensional model of the physical environment.

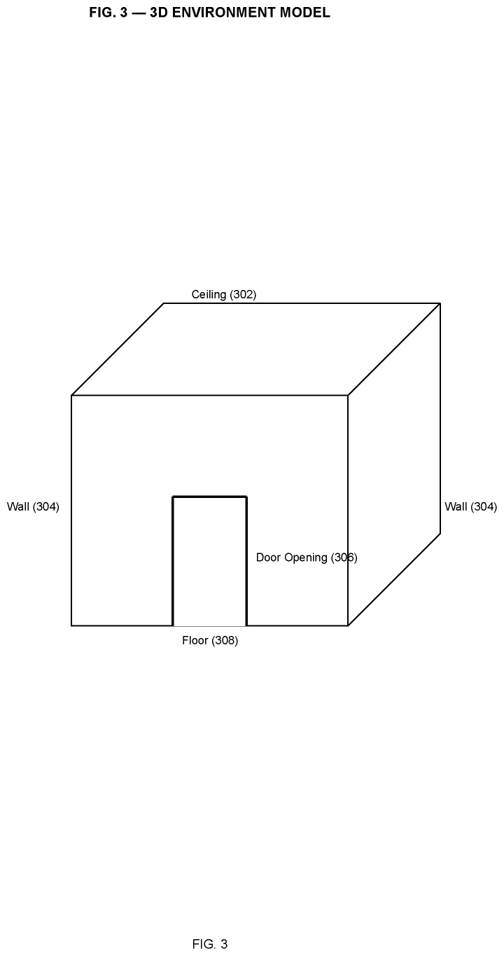

FIG. 4 illustrates determining dimensional characteristics of an object to be moved.

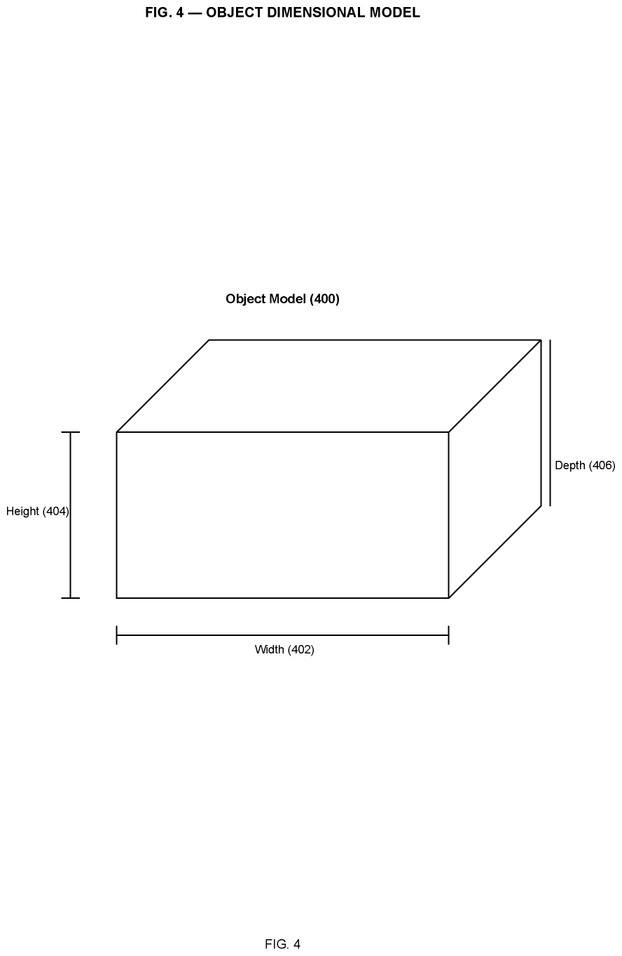

FIG. 5 illustrates simulation of object movement through the environment including rotational and translational path modeling.

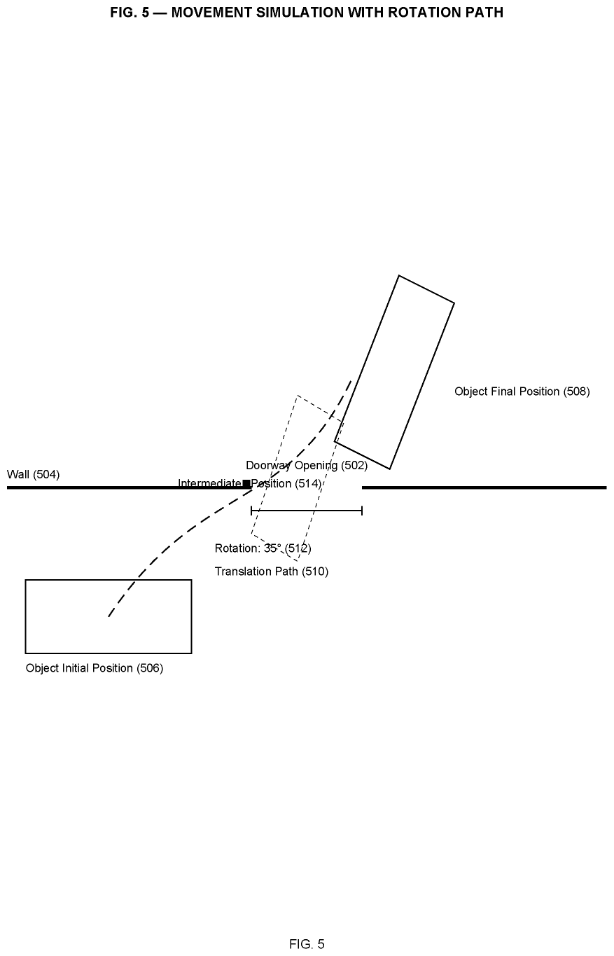

FIG. 6 illustrates detection of collision conditions during movement simulation.

FIG. 7 illustrates determination of a feasible collision-free movement path.

FIG. 8 illustrates an augmented reality interface for providing step-by-step movement guidance.

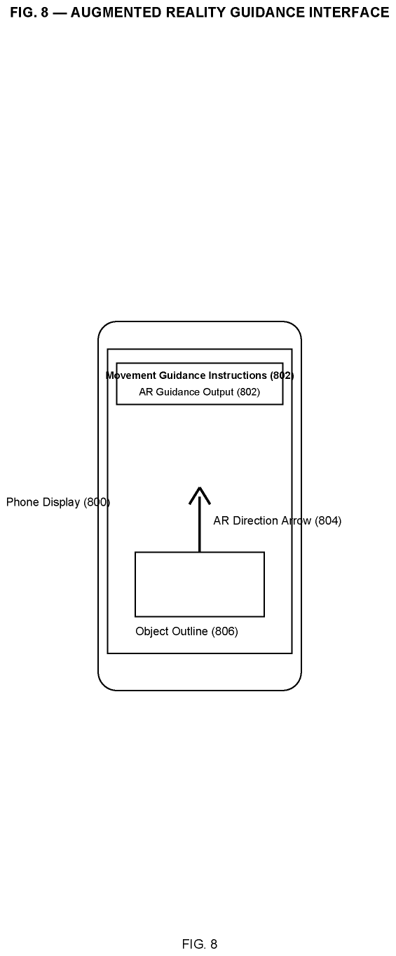

FIG. 9 illustrates a retail pre-purchase delivery feasibility verification implementation.

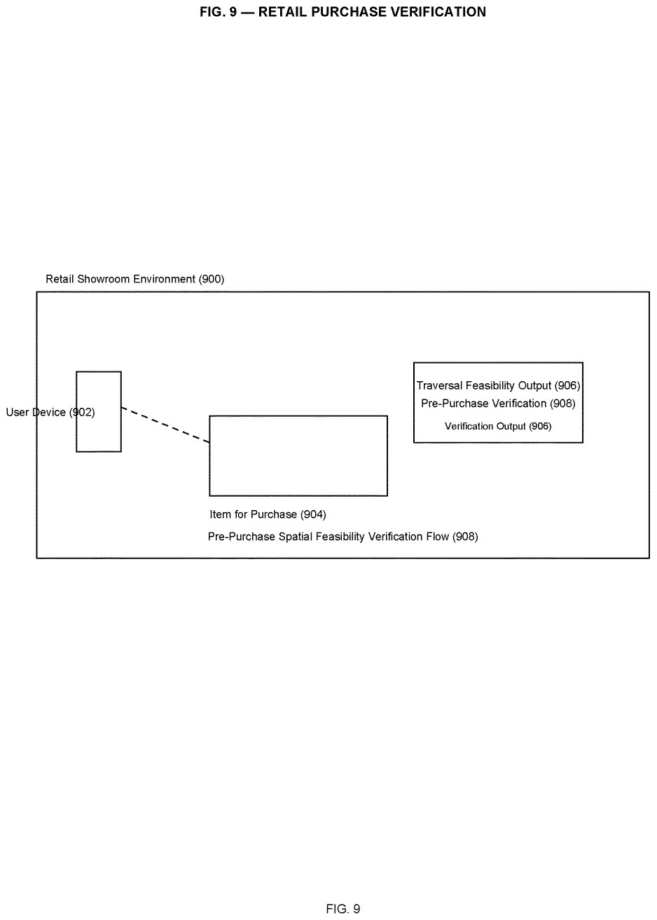

FIG. 10 illustrates a delivery and logistics path verification implementation.

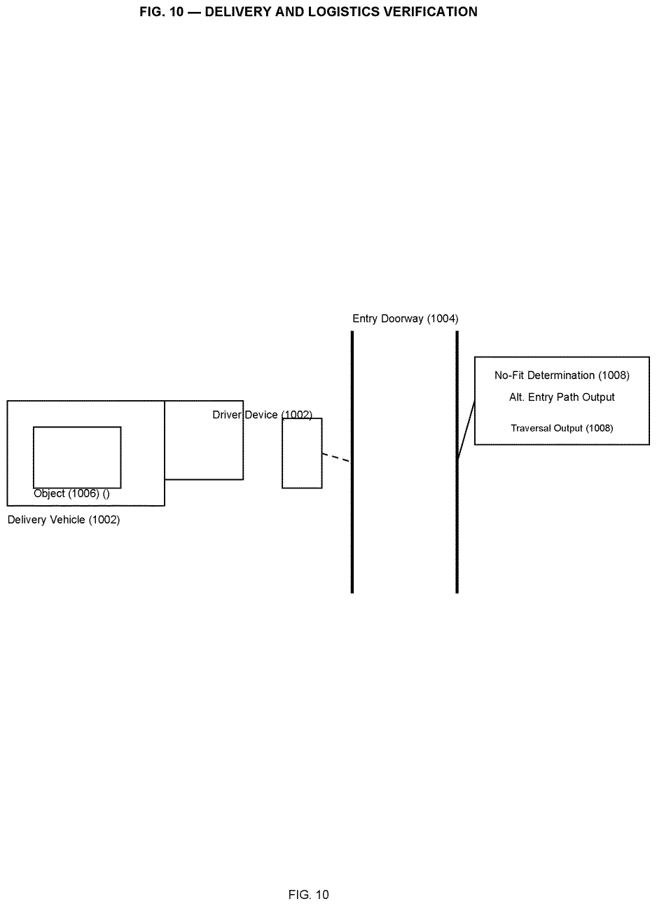

FIG. 11 illustrates the spatial fit analysis algorithm flow including swept-volume computation and feasibility determination.

FIG. 12 illustrates rotation envelope analysis showing the swept volume occupied by an object during rotational movement through a constrained opening.

FIG. 13 illustrates a multi-segment traversal path analysis for objects moving through complex environments including staircases and multiple constrained passages.

### DETAILED DESCRIPTION OF THE INVENTION

### Overview

The present disclosure describes systems and methods for determining whether an object can traverse a physical environment by computing a swept volume representing the spatial envelope occupied by the object during simulated rotational and translational movement, and detecting intersections between the swept volume and environmental boundary structures.

Unlike prior approaches that compare static object dimensions against opening dimensions, the disclosed systems model the dynamic geometry of object movement through space. When an object is moved through a constrained environment, it must simultaneously translate and rotate to navigate doorways, hallways, stairwells, and other constrained passages.

The space occupied by the object during this combined motion defines a swept volume that may differ substantially from the object's static bounding box. The present disclosure provides systems and methods that accurately compute and analyze this swept volume to determine traversal feasibility.

### Technical Field and Eligibility

The claimed systems and methods are directed to a specific improvement in computer-implemented spatial modeling technology. The invention solves a concrete technical problem—accurate determination of whether a three-dimensional rigid body can traverse a constrained physical environment through combined rotational and translational motion—that was previously unsolvable by conventional dimensional comparison methods. Prior art systems that compare static object dimensions against opening dimensions fail to account for the dynamic swept geometry of moving objects and therefore cannot accurately predict traversal feasibility in real-world constrained environments. The disclosed systems and methods achieve a measurable improvement in computational accuracy over prior approaches by replacing imprecise static bounding-box comparisons with dynamic swept-volume computation, thereby reducing prediction error and enabling reliable traversal feasibility determination across a range of constrained spatial environments.

The claimed methods produce concrete, real-world technical results: a computed swept-volume spatial model representing the complete spatial envelope occupied by a moving object, a collision detection determination identifying whether that swept volume intersects environmental boundary structures, and a traversal feasibility output indicating whether a collision-free path exists. These results are rooted in specific computer-implemented spatial computing techniques—including three-dimensional environment modeling, swept-volume computation, and collision geometry analysis—and are directed to an improvement in computer-based spatial modeling systems, not to an abstract idea, mathematical concept, or mental process. The invention achieves a technical result that improves upon prior spatial analysis systems by accurately modeling the dynamic geometry of object motion rather than relying on static dimensional comparisons, producing a reduction in computational prediction error and enabling traversal feasibility determinations that were not achievable by prior art methods.

The improvement provided by the disclosed systems is specifically technological in nature: the computation of a swept volume representing the union of all spatial positions occupied by an object during simulated rotational and translational movement, and the detection of intersections between that swept volume and environmental boundaries, constitutes a specific technical solution implemented on a computing device that produces a concrete and useful result—traversal feasibility determination—that has direct practical application in residential moving, logistics, retail commerce, construction, and robotic automation contexts.

### Computing Device and Sensors

In certain embodiments, a computing device (100) comprises a mobile device such as a smartphone or tablet computer incorporating one or more sensors (102) for capturing spatial data. Sensors may include one or more of: a camera, a depth sensor, a LiDAR sensor, an infrared sensor, an ultrasonic sensor, an inertial measurement unit, or other spatial detection technologies. In certain embodiments, the computing device may communicate with remote computing resources through a network connection, enabling portions of the spatial modeling, swept-volume computation, and collision detection processing to be performed on remote servers or cloud computing infrastructure.

### Spatial Data Capture and Environment Modeling

A spatial data capture module (104) processes sensor data to extract spatial information representing the physical environment. The spatial data is processed by a three-dimensional modeling module (108) to generate a three-dimensional representation of the environment including structural elements such as walls (204, 304), doorways (206, 306), ceilings (302), floors (208, 308), and other obstacles or boundaries.

In certain embodiments, the three-dimensional model is generated using depth mapping, point cloud reconstruction, photogrammetry, simultaneous localization and mapping (SLAM), or other spatial reconstruction techniques. The resulting environment model captures dimensional characteristics of structural elements including the width, height, and geometry of passages through which traversal is to be evaluated.

### Object Dimensional Modeling

Dimensional information describing an object (400) to be moved is obtained through one or more of: user input, product specification data retrieved from a product database, automated dimensional recognition from sensor data, or manual measurement input. The object model (400) captures the three-dimensional geometry of the object including width (402), height (404), depth (406), and any irregular dimensional features relevant to movement planning.

### Swept-Volume Computation and Movement Simulation

A simulation engine (110) evaluates potential movement of the object through the three-dimensional environment model by analyzing candidate movement paths comprising combinations of translational and rotational motion. For each candidate movement path, the simulation engine computes a swept volume representing the union of all spatial positions occupied by the object during the simulated movement.

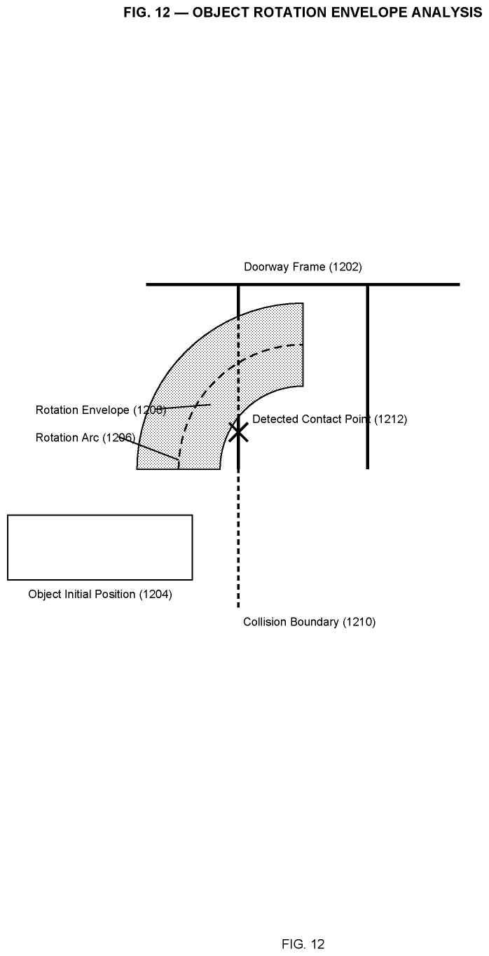

The swept volume represents the complete spatial envelope traced by the object as it simultaneously translates and rotates through the environment. As illustrated in FIG. 12, when an object rotates through a doorway opening (1202), the object (1204) traces a rotation arc (1206) that defines a rotation envelope (1208) substantially larger than the object's static dimensions. The rotation envelope represents the swept volume for rotational movement components.

In certain embodiments, the simulation engine evaluates candidate movement paths by searching across a space of rotational angles and translational displacements, evaluating the swept volume at each candidate position, and identifying movement paths for which the swept volume does not intersect environmental boundary structures.

### Collision Detection and Feasibility Determination

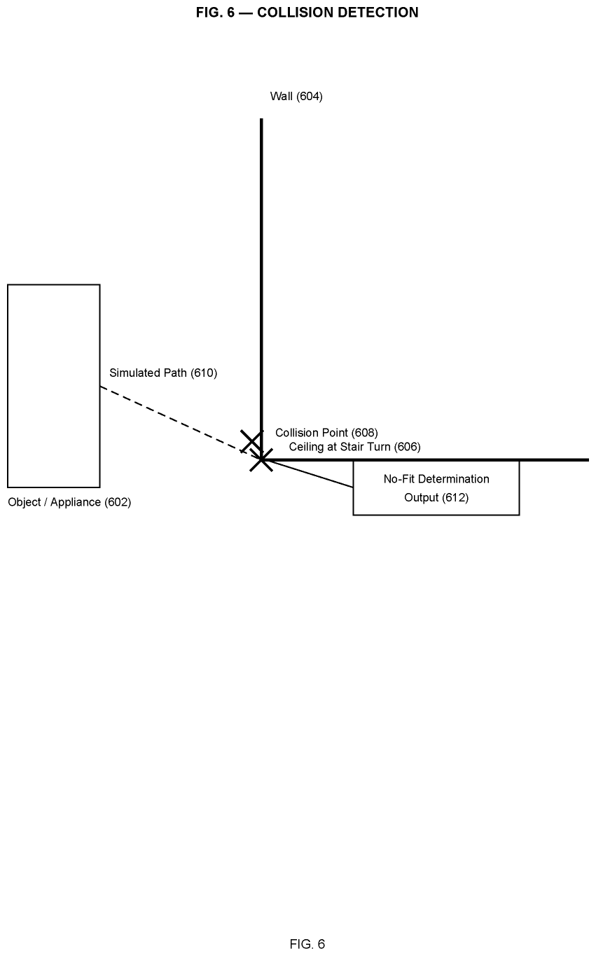

A collision detection module (111) evaluates intersections between the computed swept volume and structural boundaries of the physical environment. As illustrated in FIG. 6, when the swept volume of an object (602) intersects a wall (604), ceiling, floor, or other structural element, a collision condition is detected and a collision point (606, 608) is identified.

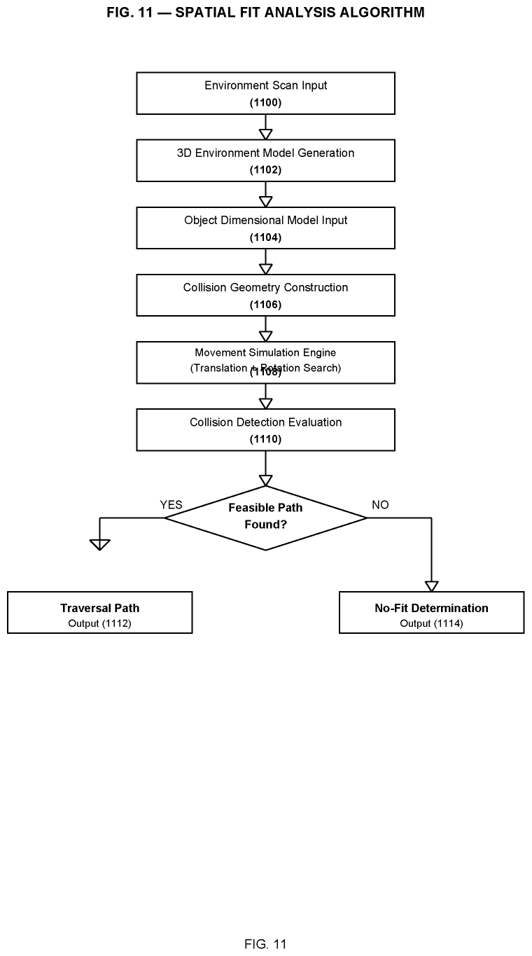

As illustrated in the algorithm flow of FIG. 11, the system receives environment scan input (1100), generates a three-dimensional environment model (1102), receives object dimensional model input (1104), constructs collision geometry (1106), executes the movement simulation engine (1108), and performs collision detection evaluation (1110). Based on the collision detection results, the system determines whether a feasible traversal path exists (1112) or generates a no-fit determination output (1114).

When no collision-free path exists for any evaluated movement combination, the system outputs a no-fit determination indicating that the object cannot traverse the environment along the evaluated path. In certain embodiments, the system may suggest alternative entry paths, alternative object orientations, or object disassembly as remedial options.

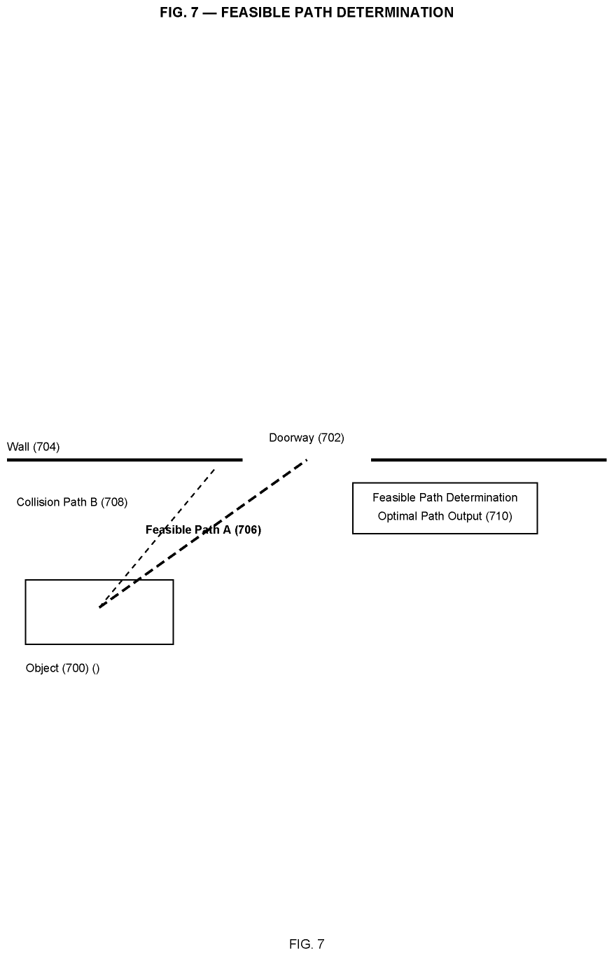

In certain embodiments, when one or more collision-free traversal paths are identified, the system selects among them based on an optimization criterion comprising one or more of: maximizing clearance margin between the swept volume and structural boundaries, minimizing required rotational complexity, minimizing total movement distance, minimizing predicted user effort, or minimizing the number of movement segments, optionally subject to real-time environmental constraints detected by the sensors. This optimization-based selection corresponds to the traversal path output described with reference to FIG. 7 and FIG. 11.

### Augmented Reality Guidance Interface

When a feasible collision-free traversal path is identified, the system generates movement guidance instructions presented through an augmented reality overlay (804) displayed on the computing device (800). The augmented reality interface displays directional indicators (804), rotation angle guidance, and step-by-step instructions overlaid on the real-world environment as captured through the device camera.

In certain embodiments, the augmented reality guidance provides instructions such as rotational angle specifications (e.g., “Tilt 35 degrees”), directional movement indicators, and sequential step-by-step movement guidance enabling users without spatial reasoning expertise to successfully navigate the object through the constrained environment.

### Multi-Segment Traversal Path Analysis

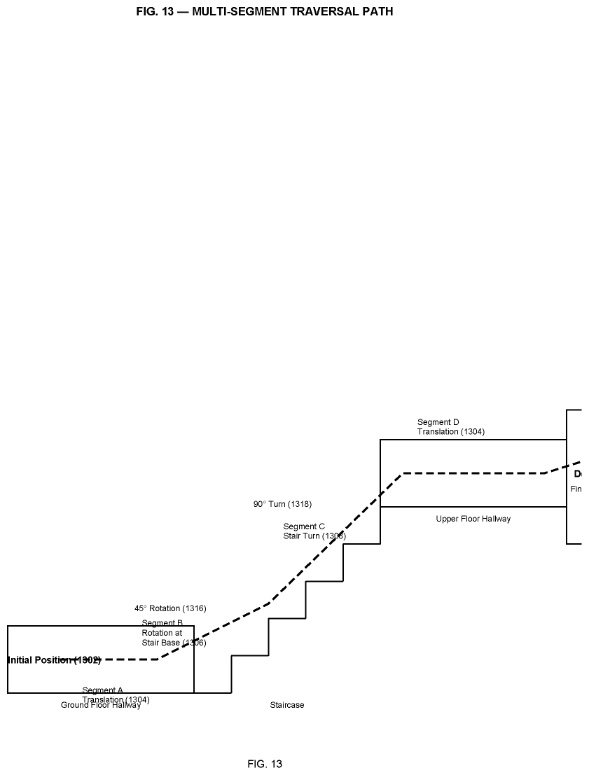

In certain embodiments, as illustrated in FIG. 13, the system evaluates multi-segment traversal paths for objects that must traverse complex environments comprising multiple constrained passages in sequence. A multi-segment path may comprise translational segments (1304), rotational segments at constrained passages (1306), stair turn segments (1308), and final positioning at a destination (1310). The system evaluates swept-volume collision conditions at each segment of the path to determine overall traversal feasibility for the complete multi-segment route.

### Retail Pre-Purchase Verification Embodiment

In certain implementations, a user captures spatial data representing entry paths within a building prior to purchasing an item from a retail platform (900). The user device (902) scans doorways, hallways, stairwells, and other constrained passages. The system evaluates whether the item (904) can traverse the captured environment and generates a verification output (906) indicating delivery feasibility prior to purchase. The output may be transmitted to the retail platform to facilitate informed purchase decisions and reduce delivery failure rates.

### Logistics and Delivery Verification Embodiment

In certain implementations, a delivery driver uses a computing device (1002) to capture spatial data representing entry paths at a delivery location. The system evaluates whether the object (1006) can traverse the entry path prior to unloading the object from a delivery vehicle.

The traversal output (1008) may indicate that the object can be delivered through a primary entry, recommend an alternative entry path, or indicate that traversal is not feasible through any evaluated path.

### Robotics and Warehouse Automation Embodiment

In certain embodiments, the system may be integrated with automated material handling systems or robotic movement systems. A robotic platform captures spatial data representing warehouse environments.

Movement paths are simulated within the modeled environment while accounting for rotational and translational movement constraints of the robotic platform. Collision detection algorithms determine whether an object can traverse the environment without contacting structural elements. When a feasible path is identified, movement instructions may be transmitted to a robotic control system.

In certain embodiments, the object comprises an item grasped or carried by a robotic manipulator arm, and the traversal path represents a manipulation trajectory to be executed by the robotic system. The swept-volume computation accounts for the combined geometry of the robotic manipulator and the grasped object during simulated movement through the environment. The system determines whether the combined swept volume of the manipulator and object intersects any environmental boundary, and generates a collision-free manipulation trajectory for transmission to the robotic control system. This embodiment applies to industrial robotic arms, warehouse picking systems, autonomous delivery robots, and surgical robotic systems operating in constrained spatial environments.

What is claimed is:

1. A computer-implemented method for determining spatial traversal feasibility of an object through a physical environment, comprising: obtaining spatial data representing the physical environment, wherein the spatial data is captured by one or more sensors or retrieved from a stored spatial model; generating a three-dimensional model of the physical environment from the spatial data; obtaining dimensional information describing the object; evaluating a plurality of candidate movement paths comprising combinations of rotational and translational movement of the object through the three-dimensional model of the physical environment; computing, for each candidate movement path, a swept volume representing the complete spatial envelope occupied by the object during the simulated rotational and translational movement along that path; detecting intersections between each swept volume and structural boundaries of the physical environment; determining whether one or more collision-free traversal paths exist based on the detected intersections; selecting a traversal path from among any identified collision-free traversal paths, wherein the selection is based on at least one optimization criterion; and generating movement instructions for the selected traversal path.

2. The method of claim 1, wherein the one or more sensors comprise at least one of a camera, a LiDAR sensor, or a depth sensor.

3. The method of claim 1, wherein the spatial data is retrieved from at least one of a stored building scan, an architectural CAD model, or a building information model.

4. The method of claim 1, wherein the computing device comprises a mobile device.

5. The method of claim 1, wherein computing the swept volume comprises computing a rotation envelope representing the union of all spatial positions occupied by the object during rotational movement through the physical environment.

6. The method of claim 1, wherein the simulating comprises searching across a space of candidate movement paths comprising combinations of rotational angles and translational displacements.

7. The method of claim 1, wherein generating movement instructions comprises generating an augmented reality overlay displayed on a computing device, wherein the augmented reality overlay includes rotational angle guidance and directional movement indicators.

8. The method of claim 1, further comprising, when no collision-free traversal path exists, generating an output indicating that the object cannot traverse the physical environment and identifying at least one alternative entry path.

9. The method of claim 1, further comprising evaluating a multi-segment traversal path comprising a plurality of sequential movement segments through the physical environment, wherein at least one segment comprises rotational movement at a constrained passage.

10. The method of claim 9, wherein the plurality of sequential movement segments includes at least one stairwell segment.

11. The method of claim 1, further comprising, prior to a purchase transaction, receiving dimensional information describing an item offered for purchase from a retail platform, and generating a verification output transmitted to the retail platform indicating whether the item can traverse the physical environment.

12. The method of claim 1, wherein at least a portion of the three-dimensional modeling, swept-volume computation, or collision detection is performed by a remote computing system communicating with the computing device through a network.

13. The method of claim 1, further comprising selecting a traversal path that optimizes at least one of required rotation magnitude, movement distance, or predicted collision proximity.

14. The method of claim 1, wherein the swept volume is computed using a voxelized spatial representation of the physical environment, wherein the physical environment is discretized into a three-dimensional grid of voxels for collision detection evaluation.

15. The method of claim 1, wherein the object comprises a plurality of articulated segments, and wherein the swept volume is computed based on the combined spatial envelope of all articulated segments during simulated movement.

16. A system for determining spatial traversal feasibility of an object through a physical environment, comprising: one or more sensors configured to capture spatial data representing the physical environment; at least one processor; and memory storing instructions that, when executed by the at least one processor, cause the system to: obtain spatial data representing the physical environment, wherein the spatial data is captured by the one or more sensors or retrieved from a stored spatial model; generate a three-dimensional model of the physical environment from the spatial data; obtain dimensional information describing the object; evaluate a plurality of candidate movement paths comprising combinations of rotational and translational movement of the object through the three-dimensional model; compute, for each candidate movement path, a swept volume representing the complete spatial envelope occupied by the object during the simulated movement, wherein the swept volume comprises a rotation envelope representing all spatial positions occupied by the object during rotational movement; detect intersections between each swept volume and structural boundaries of the physical environment; determine whether one or more collision-free traversal paths exist; select a traversal path from among any identified collision-free traversal paths, wherein the selection is based on at least one optimization criterion; and generate movement instructions for the selected traversal path.

17. The system of claim 16, wherein the system is implemented on a mobile computing device.

18. The system of claim 16, further configured to present an augmented reality overlay on a display of a computing device indicating the collision-free traversal path.

19. The system of claim 16, further configured to generate a delivery feasibility output prior to unloading an object from a delivery vehicle, wherein the delivery feasibility output indicates whether the object can traverse at least one entry path at a delivery location.

20. The system of claim 16, wherein the instructions further cause the system to evaluate a plurality of candidate movement paths and rank feasible movement paths based on at least one of path length, required rotation magnitude, predicted user effort, or collision proximity margins.

21. The system of claim 16, further configured to transmit collision-free movement path instructions to an automated handling system or robotic manipulation system.

22. A non-transitory computer-readable medium storing instructions that, when executed by a computing device, cause the computing device to: obtain spatial data representing a physical environment, wherein the spatial data is captured by one or more sensors or retrieved from a stored spatial model; generate a three-dimensional model of the physical environment; obtain dimensional information describing an object; evaluate a plurality of candidate movement paths comprising combinations of rotational and translational movement of the object through the three-dimensional model; compute, for each candidate movement path, a swept volume representing the complete spatial envelope occupied by the object during the simulated movement; detect intersections between each swept volume and structural boundaries of the physical environment; determine whether one or more collision-free traversal paths exist, wherein the determination is based on whether the swept volume for each candidate path intersects any structural boundary during the simulated movement; select a traversal path from among any identified collision-free traversal paths, wherein the selection is based on at least one optimization criterion; and generate movement instructions for the selected traversal path.

23. The non-transitory computer-readable medium of claim 22, wherein the instructions further cause the computing device to display an augmented reality overlay providing step-by-step rotational and translational movement guidance along the collision-free traversal path.

24. The non-transitory computer-readable medium of claim 22, wherein the instructions further cause the computing device to generate a no-fit output when no collision-free traversal path exists, and to identify at least one alternative entry path.

25. The non-transitory computer-readable medium of claim 22, wherein the instructions further cause the computing device to evaluate a multi-segment traversal path through a physical environment comprising a plurality of sequentially constrained passages, and to generate sequential movement guidance for each segment.

26. The method of claim 1, wherein selecting the traversal path comprises computing a clearance margin value for each candidate movement path, wherein the clearance margin value represents a minimum spatial distance between the swept volume and any structural boundary along the path, and selecting the traversal path that maximizes the clearance margin value.

27. The method of claim 1, further comprising ranking each identified collision-free traversal path according to an optimization score computed based on one or more of: required rotation magnitude, total movement distance, predicted user effort, minimum clearance margin, or number of movement segments; and presenting the ranked traversal paths to a user.

28. The method of claim 1, further comprising generating a traversal feasibility confidence score representing a probability that the object can traverse the physical environment based on dimensional uncertainty in at least one of the spatial data or the dimensional information describing the object, including uncertainty attributable to sensor accuracy variance, wherein the confidence score is transmitted to a user interface or a third-party platform as part of the traversal feasibility output.

29. The method of claim 1, further comprising continuously re-evaluating traversal feasibility in real time as updated spatial data is received from the one or more sensors during movement of the object through the physical environment, and dynamically updating the movement instructions based on the re-evaluation.

30. The method of claim 1, wherein computing the swept volume comprises representing the swept volume using a continuous geometric representation of the spatial envelope occupied by the object during rotational and translational movement, wherein the continuous geometric representation is computed independently of any discretized voxel grid representation of the physical environment.
